(19) United States
(12) Patent Application Publication
(10) Pub. No.: US 2016/0063212 A1
(43) Pub. Date: Mar. 3, 2016

(54) System for Generating and Updating Treatment Guidelines and Estimating Effect Size of Treatment Steps

(71) Applicant: Kyron, Inc., Palo Alto, CA (US)

(72) Inventors: Louis Monier, Palo Alto, CA (US); Noah Zimmerman, Palo Alto, CA (US); Bethany Percha, Palo Alto, CA (US)

(21) Appl. No.: 14/843,343

(22) Filed: Sep. 2, 2015

Related U.S. Application Data
(60) Provisional application No. 62/044,866, filed on Sep. 2, 2014.

(51) Int. Cl. G06F 19/00

(52) U.S. Cl. CPC G06F 19/3437; G06F 19/322; G06F 19/3443

(57) ABSTRACT

Medical guidelines are generated based on the history of the medical records for a large patient population, which includes creating a patient trajectory graph from the records including nodes and edges by automatically clustering patients based on relevant the patients' features included in their medical records. The nodes are scored based on the time patients remain with the nodes and desirability of any associated outcomes, resulting in edge scores derived from the scores of the edge-connected nodes. Top ranked interventions obtained from the edge scores that evaluates whether a transition from one node to another is better or worse are included in the generated medical guidelines. Additionally, effect sizes and confidence intervals of medical treatments for a pre-defined patient population are estimated by using the patients' medical records and dividing the population in an exposed and non-exposed group. Estimates are based on match choices between exposed and non-exposed patients.

### CROSS REFERENCE TO RELATED APPLICATIONS

The application claims the benefit of Provisional Application No. 62/044,866, filed on Sep. 2, 2014, the content of which is incorporated herein by reference.

### BACKGROUND

1. Field of Art

The present disclosure relates generally to digital records, and, more particularly, to systems and methods for estimating treatment outcomes and providing treatment guidelines to physicians based on these medical records.

2. Description of the Related Art

Medical guidelines for treating a patient are typically created by health care agencies or institutions, e.g., American Heart Association, hospital, medical authorities or health maintenance organizations. These guidelines cover many different medical disorders and diseases and provide physicians with recommendations and protocols for treating a patient with such disorders or diseases. Medical experts who review clinical and research studies oftentimes assemble these guidelines based on results of these studies, which in some instances involve large and diverse patient populations. Moreover, the guidelines are based on the experts' own subjective experiences, opinions and biases, which oftentimes lead to contradictory guidelines due to opinions differing among the experts, and obfuscate the objective relationship between the study results and the adopted line of treatment in the corresponding guideline. Thus, only a limited number of recommendations in guidelines on how to treat a patient having a particular medical condition can be traced back to actual data obtained from medical studies or real outcomes of treating actual patients. In contrast, many recommendations included in the guidelines are more often than not purely based on expert opinion.

Attempts to generate useful and accurate medical guidelines using computational algorithms have been largely unsuccessful. One problem associated with guidelines derived in an automated manner lies in their rule-based approach that provides bright-line rules for how to treat a patient under particular circumstances. For example, a recommendation to administer an anticoagulant agent may depend on the blood pressure of a patient. Only if the patient's blood pressure exceeds a specified threshold value should the physician administer an anticoagulant to the patient. However, since the physiological and medical condition of one patient relative to another often varies significantly, a threshold value that is applicable to all patients cannot be ascertained. The complexity of rule-based guidelines increases rapidly when considering not just one but multiple physiological parameters (symptoms) of a patient, since each parameter represents an additional conditional layer in a treatment protocol. Furthermore, rule-based guidelines cannot easily accommodate real-life ambiguity, which results from a patient's exhibiting two symptoms which are part of different branches of a decision tree, potentially leading to orthogonal treatment recommendations. Rule-based guidelines therefore often contain inconsistencies with regard to actual patient scenarios, leaving it to the treating physician to reconcile these inconsistencies.

Furthermore, current guidelines lack accurate estimates of patients' outcomes when following the recommended treatment protocol. For patients of a particular treatment these estimates are based on evaluating epidemiological studies “at the bedside,” which involves using patient data already collected in the course of treatment to determine future treatment steps for these or other patients at the same facility. Epidemiological studies must therefore be conducted in real time and depend heavily on the accuracy of the observed data, in particular data included in electronic medical records. However, due to medical emergencies and other stress factors, these data are often inaccurate, incomplete and noisy with irrelevant information obscuring the important and relevant data.

Epidemiological studies invoke a matching scheme when evaluating small-sized patient populations, e.g. patients exhibiting a rare or unusual medical condition. Patients of these populations are matched on the basis of factors like age, gender, and other study-specific variables identified by the investigators of the study to confound the study outcome. For example, patients who have received a drug are matched with patients having similar physiological characteristic, but did not receive the drug (or received a different drug). Such a match is then used to determine whether side effects experienced by these patients relate to the administered drug. In this case, one would want to ensure that the group of patients receiving the drug was not systematically different from the other group on the basis of features like age, race, income, hospital, or geographic location. Such differences could lead to erroneous estimates of the effect of the drug on treatment response. These additional factors are called cofounders.

### SUMMARY

A medical guideline generation system, and its corresponding method, generates medical guidelines based on data from the electronic medical records of a large number of patients. Furthermore, an effect size estimation system, and its corresponding method, calculates an estimate of the effect size of a medical treatment or intervention for a specified patient population.

Clinical practice guidelines codify the best available evidence for the delivery of healthcare. The guidelines are created by researchers and professional organizations and disseminated in lengthy publications, but it is difficult for physicians to determine the most relevant guideline or the portion with actionable treatment decisions for a given patient, to obtain an up-to-date copy of that guideline, or to match the state of the patient to the appropriate treatment decision.

Embodiments of the present disclosure provide methods for the creation, representation and application of clinical treatment guidelines from a large corpus of clinical data, including assessing the impact of missing data on a treatment recommendation, providing a recommendation in the presence of incomplete data, prioritizing a list of recommendations based on the quality of the match between the patient state and the treatment recommendation, and quantifying the confidence in the recommendation.

In one embodiment, a method for generating recommendations for medical guidelines includes: creating a patient trajectory graph based on a plurality of medical records, the patient trajectory graph comprising a plurality of nodes and edges, each edge connecting a node with itself or two separate nodes; scoring each node included in the patient trajectory graph and calculating scores of the edges based on the nodes connected to the edge; identifying medical interventions that associated with an edge by parsing medical records associated with nodes that the edge connects; and ranking the identified medical interventions based on the associated edge score; and outputting the top ranked medical interventions as recommendations for medical guidelines.

Another embodiment, a method for estimating an effect size of a medical treatment on a patient population includes: identifying common features among the patient population based on evaluating medical records of patients included in the patient population; dividing a patient belonging to the patient population into an exposed or non-exposed group depending on whether the patient received the medical treatment or not; sampling match choices between patients in the exposed and the non-exposed by bucketing patients according to the identified common features; determining an effect size for each sampled match choice; and outputting an averaged effect size and its corresponding statistics by averaging the effect size of each sampled match choice.

### BRIEF DESCRIPTION OF DRAWINGS

FIG. 1 is an illustration of a medical guideline generation system in accordance with one embodiment.

FIG. 2 illustrates a the feature generation module determining a feature matrix form a history of patient records and selecting feature from such matrix in accordance with one embodiment.

FIG. 3 illustrates grouping patients into nodes within constant time intervals for creating a patient trajectory graph in accordance with one embodiment.

FIG. 4 is a flow chart illustrating a method for processing medical records to determine and select common patient features in accordance with one embodiment.

FIG. 5 illustrates a patient trajectory graph in accordance with one embodiment.

FIG. 6 is a flow chart illustrating a method for generating medical guidelines based on a patient trajectory graph in accordance with one embodiment.

FIG. 7 is a flow chart illustrating a method for generating medical guidelines based on training a model for a specified patient population in accordance with one embodiment.

FIG. 8 is an illustration of an effect size estimation system in accordance with one embodiment.

FIG. 9 illustrates bootstrapping a patient population into different match choices based on common confounders in accordance with one embodiment.

FIG. 10 is a flow chart illustrating a method for estimating an effect size of a treatment or medical intervention based on a specified patient population in accordance with one embodiment.

FIG. 11 is an illustration of a computing environment of a medical guideline generation system or an effect size estimation system in accordance with one embodiment

One skilled in the art will readily recognize from the following discussion that alternative embodiments of the structures and methods illustrated herein may be employed without departing from the principles of the invention described herein.

### DETAILED DESCRIPTION

### System for Generating Medical Guidelines

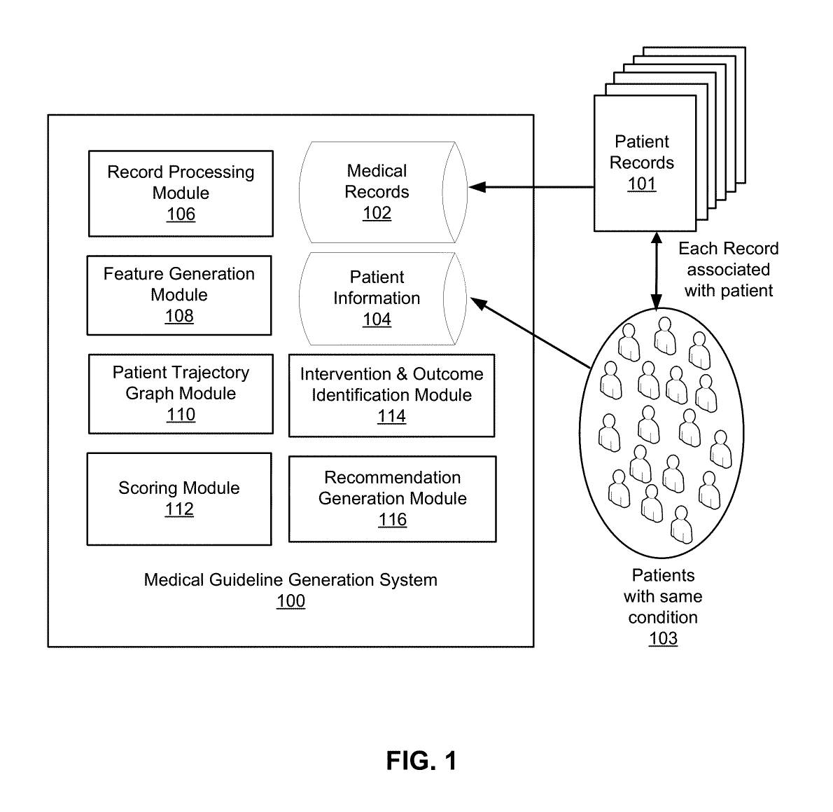

FIG. 1 is an illustration of a medical guideline generation system 100 in accordance with one embodiment. The medical guideline generation system 100 generates medical guidelines for healthcare professionals by: (i) processing medical records, (ii) identifying features and medical outcomes within those records, (iii) determining patient trajectory graphs from those features and outcomes, and (iv) generating medical guidelines based on scored interventions within those graphs. To perform these various functions, the medical guideline generation system 100 includes a record processing module 106, a feature generation module 108, a patient trajectory graph module 110, a scoring module 112, an intervention and outcome identification module 114, and recommendation generation module 116. The system 100 also includes data stores such as a medical records store 102 and a patient information store 104 for storing data associated with the patients, including their medical records, and other data needed to identify features and outcomes among those patients. Each of the modules and data stores included in the system 100 is discussed in detail below.

The medical records store 102 and patient information store 104 provide access to longitudinal patient data from electronic medical records 103. Individual patient information is stored in the patient information store 104, whereas the patient's corresponding medical records are stored in the medical records store 102. Separating the personal information from the actual medical records allows for patient anonymity and compliance with privacy and medical health record laws. In another embodiment, a patient's personal information is included in her medical record and stored with the record in the medical records store 102. Each medical record in the medical records store 102 is associated with the personal patient information in the patient information store. In one embodiment, the medical record of a particular patient is also associated with a unique patient identification (ID) number. Using this unique ID number allows each medical record and patient information to be associated with the patient identified through this number. Each of these stores may be a database or any other data storage system. While the illustrated embodiment shows the stores as being internal to the medical guideline generation system 100, other embodiments where the stores are external to the medical guideline generation system 100, such as executing in a complementary server or on a cloud-based system managed by a third-party, are within the scope.

The record processing module 106 processes each medical record for generating medical guidelines based on these processed records, according to one embodiment. Initial processing of the medical records stored in the medical records store 102 includes identifying those medical records that include temporal references, i.e. date and time, when the events described in the record occurred. Identifying the date and time of events allows the record processing module 102 to generate a history of medical records, detailing the timeline of events during the treatment and observation of each patient. To study the history (time-ordered trajectory) of patients and assess treatment outcomes along those trajectories, medical records for long time periods are preferably included in determining guideline steps. Each patient's medical history is part of the patient profile, including the patient's personal information. For example, a patient's history may include, but is not limited to, medications, laboratory values, vital signs, procedures, diagnoses and other medical observations that the record processing module extracts from structured and unstructured patient data. Furthermore, the record processing module 106 formats the patient records and profiles to produce formatted records that can be readily processed by the other modules of medical guideline generation system 100.

The feature generation module 108 analyzes the medical records and patient information to generate features used for determining medical guideline steps, according to one embodiment. The feature generation module parses information contained in the medical records, and associates the parsed information with pre-defined clinical or medical features. Clinical or medical features may include, but are not limited to the diagnosis of a particular medical disease or disorder, a patient's physiological symptoms, administration of a drug or other medical treatment, e.g. radiation therapy or surgery. For example, the medical condition of “diabetes” is most often associated with the terms “glucose,” “A1c,” Metformin,” and “liver failure,” among others. In addition, the feature generation module identifies medical outcomes included in a patient's medical history, and associates with the identified outcomes any features included in the same history that predate that outcome. In the above example, an identified outcome can include a patient's testing for a glucose level below a specified high value that would be indicative of diabetes. The corresponding feature in this example may be the injection of a certain amount of insulin prior the glucose test. Such a feature may also be referred to as an intervention, since it is not a physiological state of a patient, but rather represents an external event that the patient is experiencing, e.g. testing for a physiological state and administering a pharmacologically active agent. To identify features and outcomes among large record collections, the feature generation module may use terminologies, ontologies providing domain specific lexicons, and contextual annotations for use in natural language processing, indexing, and information retrieval. Examples of such terminologies, ontologies, and contextual annotations and their implementations that are used to identify medical or clinical features and associated outcomes are described in U.S. Patent Pub. No. 2013/0226616, which is incorporated by reference herein.

### Feature Generation and Selection

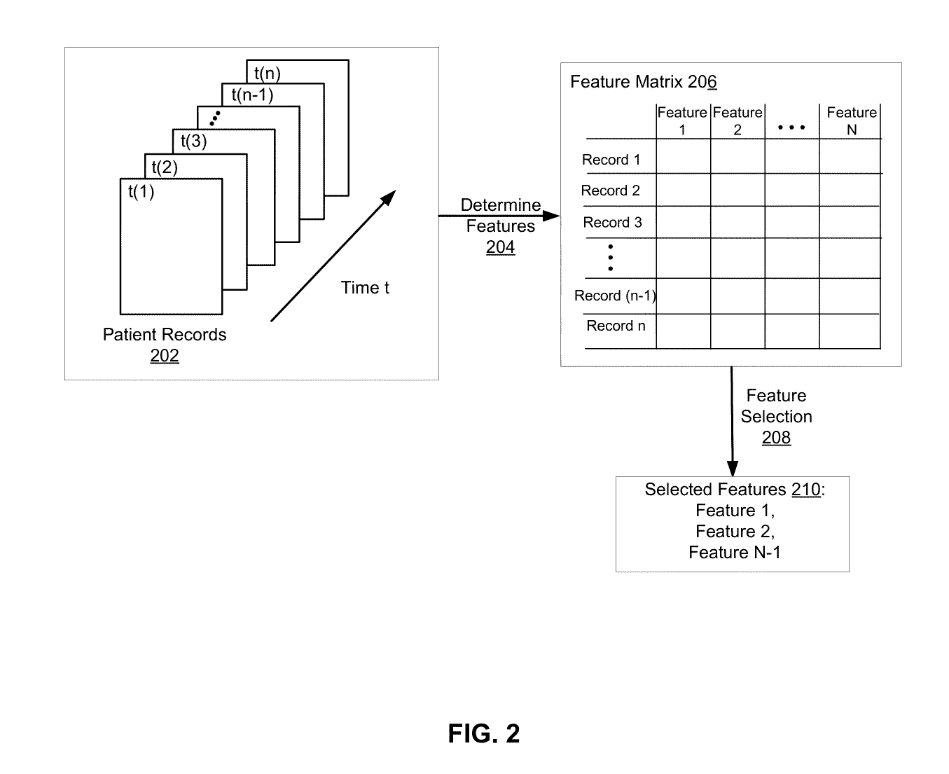

As illustrated in FIG. 2, the feature generation module 108 represents and stores the features as an (N×M×T) matrix, according to one embodiment. N represents the number of patients, M the number of features, and T the time when the corresponding features occurred. Thus, one representation of a patient's trajectory may include a three-dimensional matrix with its axis corresponding to the patients, the features, and time, respectively. Each cell Fₙₘₜ in the matrix represents a feature value Fₘₜ for a particular patient n at a time t. Furthermore, the feature generation module may represent the recorded medical outcome for each patient as a (N×1) vector at time t, wherein N again is the number of patients. At different times the entries of the outcome vector may change as a medical condition or disorder recedes or worsens.

The feature generation module 108 selects a subset of all of features generated from the medical records that span an identical time period and are associated with the same medical condition or disorder, according to one embodiment. This process is referred to as feature selection that may occur by actively including or passively removing a feature from evaluation, i.e. pruning. Generally, feature selection identifies a subset of features that are determined to be most relevant for a medical outcome. If the number of medical records is large (e.g., millions), leading to an even larger number of features, many of which may not be relevant for a later medical outcome, feature selection may help in obtaining a manageable number of features. For example, a feature indicative of the patient's geographic residence may not play a role in the outcome of a particular treatment so long as the treatment does not vary between different locations. Feature selection also reduces the chance of “overfitting” a model of outcome prediction (i.e. building a model that performs well on training data, but less well on an independent test set). The risk of overfitting increases as more features are used in the outcome model. In terms of the number of features selected for use in the model, the selection is driven by balancing the benefit of increased model accuracy over the computational cost of including additional features and the risk of overfitting. Thus, reducing the number of features not only reduces the computational cost (complexity) of the model fitting process, but also improves the model's robustness (the chance it will continue to perform well, even on new/independent datasets). For example, feature selection may initially identify a small set of relevant features (2 or more features). Since the determination of guideline steps may only include the most relevant intervening features, the risk of underfitting, i.e. selecting too few features for accurately predicting an outcome, may be ignored.

The feature generation module 108 performs feature selection by ranking features with respect to their support, confidence, or a combination of both, according to one embodiment. The feature generation module therefore calculates confidence and support for each feature. The support value supp(X) for a feature X indicates the percentage of patients in a patient population who possess this feature. On the other hand, a confidence value conf(X [symbol] Y) represents the likelihood that outcome Y is associated with feature X. Generally, confidence and support are used in association rule learning to identify association rules, i.e. implications of the form X [symbol] Y, among non-overlapping variables within a dataset. A confidence value conf(Xₜ [symbol] Yₜ₊ₙ=y) indicates the percentage of patients possessing feature Xₜ at time t who actually displayed medical outcome “y” at a later time t+n. Support and confidence values of set of features may be calculated by ranking these features. On the other hand, individual features may be ranked by support, confidence or combination of both. The feature generation module then selects a feature that achieves at least threshold minimum rank among a set of features or removes the feature if it ranks below the threshold, which maybe absolute or relative, and/or static or dynamic.

The feature generation module 108 may also select features using other association rule learning or feature selection techniques to select features, according to other embodiments. For example, the feature generation module may perform feature selection by only including features that are minimally correlated among themselves and/or by eliminating outlier features that poorly correlate with the associated medical outcome. In particular, a feature is selected from a set of features with a cross-correlation exceeding a pre-defined threshold. Other selection techniques may include, but are not limited to using mutual information, various similarity scores of features, the number of missing values for a feature, and parametric/nonparametric correlation measures among the features. Regardless of which technique is used, the feature generation module selects features that are common to a large number of patients of a patient population sharing the same medical condition or disorder.

### Generation of Patient Trajectory Graph

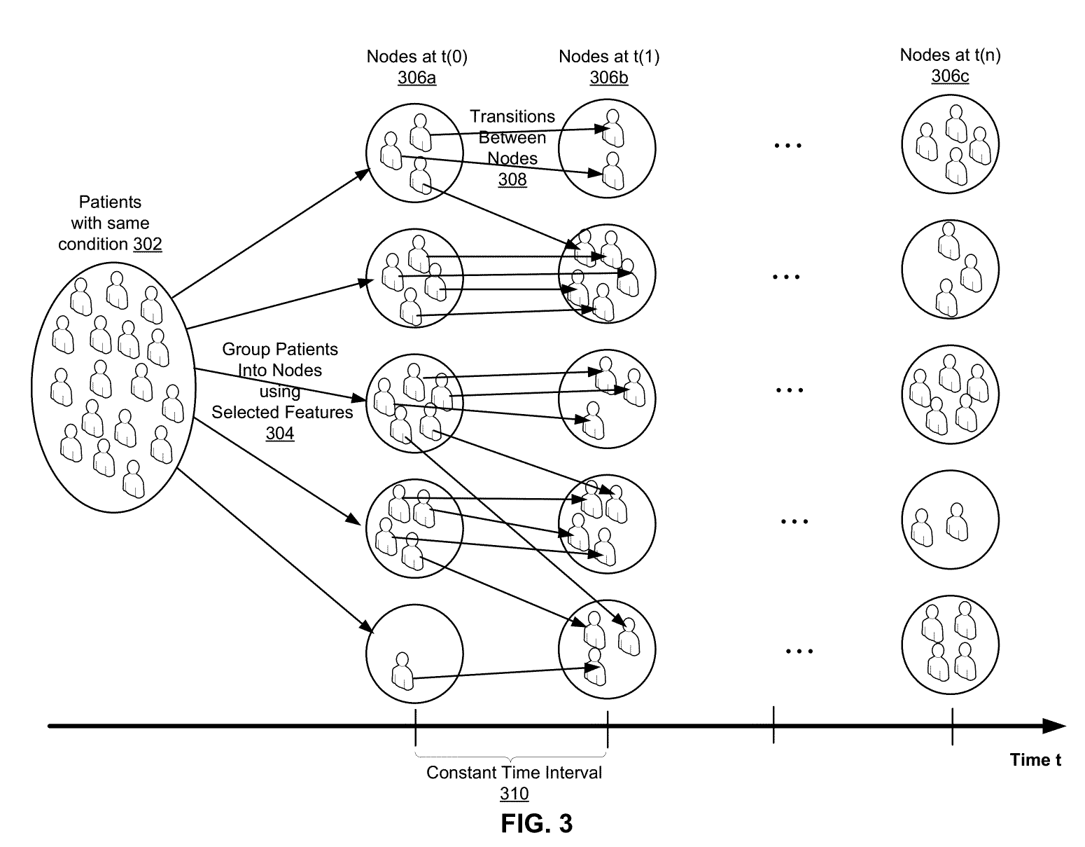

Referring to FIG. 3, the patient trajectory graph module 110 bins each patient trajectory into discrete time intervals of a specified time period, according to one embodiment. For binning the patient trajectory graph module determines the earliest time t(0) and latest time t(n) for any of the selected features generated from medical records spanning the time period t(n)-t(0), e.g. 5 years. In one embodiment, the patient trajectory graph module then divides the time period t(n)-t(0) into bins of equal duration. For example, each time bin may be 6 months apart, and a selected feature Fₘₜ with time t occurring during a particular 6-month period is associated with the corresponding time bin.

Binning of each patient trajectory into discrete time intervals means that the number of patients per bin is constant for the entire time period t(n)-t(0) with each patient considered once for a particular bin. Accordingly, the patient trajectory graph module also assigns each output vector at time t to its corresponding time bin. Thus, a time bin may include multiple selected features generated from medical records belonging to the same patient and occurring at different times during the time period of the bin. Furthermore, each bin may include one or more medical outcome associated with the patient. In one embodiment, the patient trajectory graph module may add a feature to a bin that is missing from that bin, if the same feature is encountered in the prior and subsequent bin. In particular, missing features are added that correspond to a slowly changing physiological condition, which would not be expected to have changed over the time period of a bin.

For each time bin the patient trajectory graph module 110 clusters patients sharing a similar medical condition or disorder into groups based on the selected features the patients have in common among themselves. Thus, during a particular time period patients in a group are in a “similar” state with respect to the features they share. The patient trajectory graph module may graphically represent the groups in the form of nodes of a graph. For example, patients who share a particular lab value and medication are initially grouped into “node1.” If at a later time the lab value of a patient belonging to “node1” changes, the patient trajectory graph module may group this patient into a different node, e.g. “node2,” at this later time. Furthermore, the patient trajectory graph module assigns any outcomes associated with a patient to the patient's node if the outcome occurs during the node's corresponding time bin. Thus, some nodes may capture certain outcomes of a patient's trajectory, including for example the patient's death, organ failure, or other adverse events.

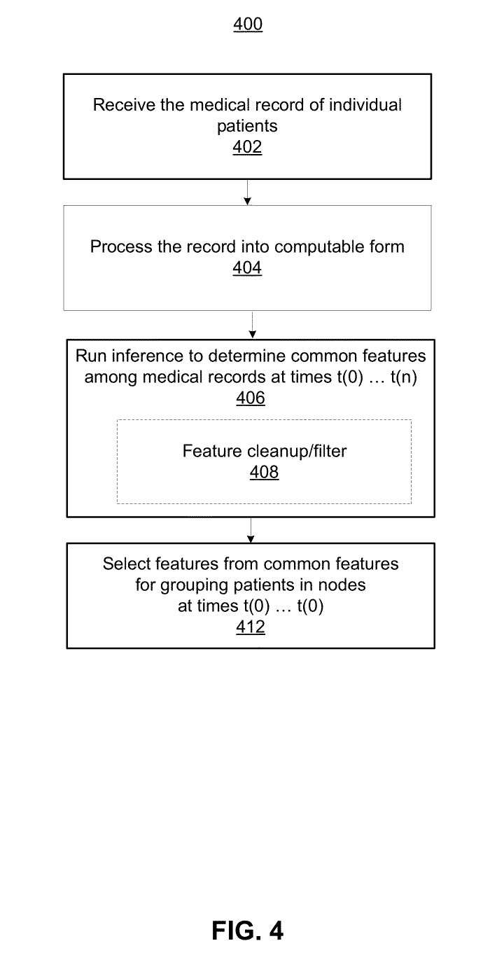

FIG. 4 is a flow chart illustrating a method for processing medical records by the record processing module 106 and generating/selecting features from those processed records by the feature generation module 108 according to one embodiment. The method includes receiving 402 a medical record for an individual patient belonging to a patient pool of patients sharing a common disease or medical condition by the record processing module 106. The record processing module 106 then processes 404 the record into a computable form before feature generation module 108 runs inference 406 on the patient records to determine common features among the medical records at times t(0) . . . t(n). In one embodiment, these features are cleaned up and filtered 408 based on pre-defined filter criteria, e.g. maximum or minimum frequencies for the different features (which results in very common or very rare features' being excluded). Subsequently, the method includes selecting 408 features from the common features by the feature generation module 108 for grouping patients into buckets at different times t(0) . . . t(n) during their treatment history.

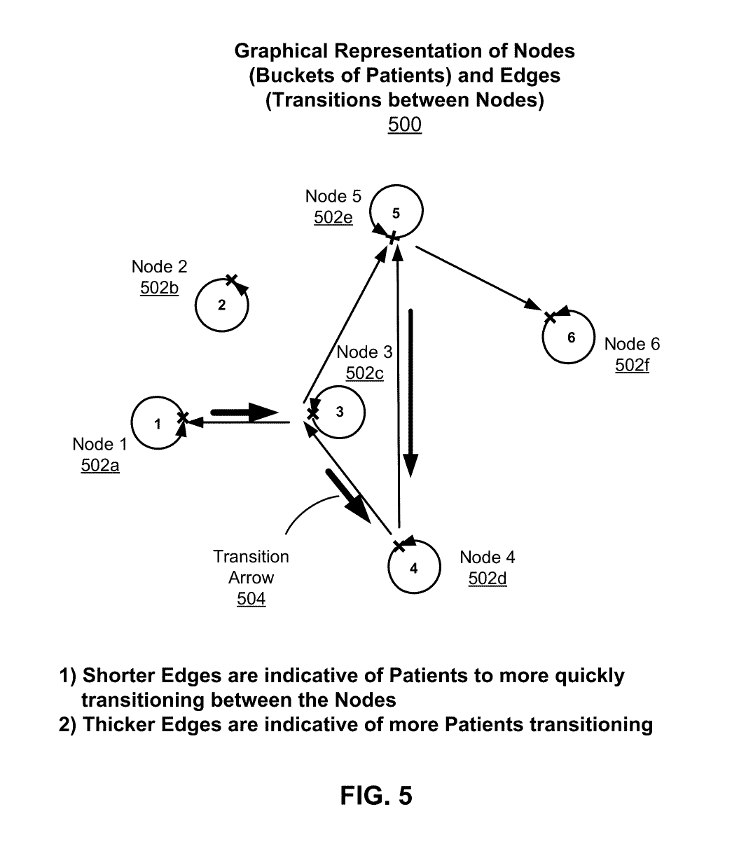

Referring to FIG. 5, the patient trajectory graph module 110 creates connections, referred to as edges, between nodes belonging to neighboring time bins for every patient of the patient population. For example, if a patient is initially in “node1” at time t and at a time t+1 is grouped into “node2,” the patient trajectory graph module generates an edge between node1 and node2. By adding the patient to edge between these nodes the module increases the patient count associated with this edge by one. On the other hand if a patient remains within the same node, the module creates an edge looping back to the same node, indicating no change of a patient's state over time. Furthermore, the thickness of each edge is representative of the number of the patients associated with the edge. Thus, the more frequently patients transition from one node to another node, the thicker the edge between these nodes. Thus, a graph of the patient trajectories may be represented by nodes representing different patient states and edges connecting these nodes and indicative of patients changing state (e.g. becoming ill with a particular disease, recovering, etc.). Some edges may result from active interventions under the control of the physician, e.g. a change in prescription, while other edges are the result of a patient reacting to a new medication, the patient's condition progressing or other non-recorded factors, e.g. compliance or diet/lifestyle changes by the patient. Steps to be included in medical guidelines mainly concern active interventions under the control of the physician. The patient trajectory graph module therefore identifies edges corresponding to active interventions and the steps included in these interventions.

### Scoring of Nodes and Edges in Patient Trajectory Graph

The scoring module 112 scores each node included in the graph depending on the patient's condition or outcomes associated with each node. If the medical condition or outcome is desirable, e.g. the patient's health is improving, the score is high. For conditions or outcomes that are undesirable, e.g. death or organ failure, the score of the corresponding node is lower, whereas the patient dying receives the lowest score. Nodes with outcomes including an increased intake of medication, increased co-morbidities and expensive treatment options also receive a lower score. In another embodiment, the more features are shared among patients belonging to a node, the lower the score of the node is. A node including many features that are costly, e.g. administering an expensive prescription drug, also receive a lower score. In some embodiments, a number of scores of a node are weighed individually and combined to yield a single score of the node. The weight of a score can be proportional to the time that patients associated with the score remain with the node before transitioning to another node. For example, a score involving a patient taking medication for a longer period of time with improving health is weighed more heavily. A transition between two nodes resulting from an intervention is scored by the difference in the scores of the node that the transition leads to and of the node the transition originates from. For example, an intervention is favored (has a positive score) if the score of the end node is greater than the start node of the intervention.

The scoring module scores all the interventions included in a patient trajectory graph for a medical condition or disorder and generates recommendations for medical guidelines regarding this medical condition or disorder based on the highest scoring interventions. To obtain more nuanced recommendations, the feature generation module can select more features to be included in generating the patient trajectory graph. In turn, an increase in selected features may lead to an increase in nodes included in the graph that results in more scored interventions and subsequently more recommendations. For example, after initially selecting only one lab and medication feature, introducing a feature for patient gender would split every existing node into two nodes, one for male patients and the other for female patients. If the transitions from these two nodes possess identical probability distributions, the scores associated with these transitions are also identical, resulting in recommendations that are ranked equally. Thus, in this case distinguishing between a male and female patient would have no effect on the resulting medical guideline. However, if interventions, e.g. increasing dosage of the current medication, result in positively scored transitions mostly from the node containing female patients and not from the corresponding node of male patients, the score of the recommendation is weighed more heavily for female patients. Thus, this intervention would likely be included in a medical guideline for female but not male patients. The medical guideline generation system can achieve further refinement of the generated recommendation by increasing the number of selected features. A natural cutoff in this refinement process occurs when the nodes contain too few patients for statistical validation of the model.

### Method of Generating & Updating Medical Guidelines

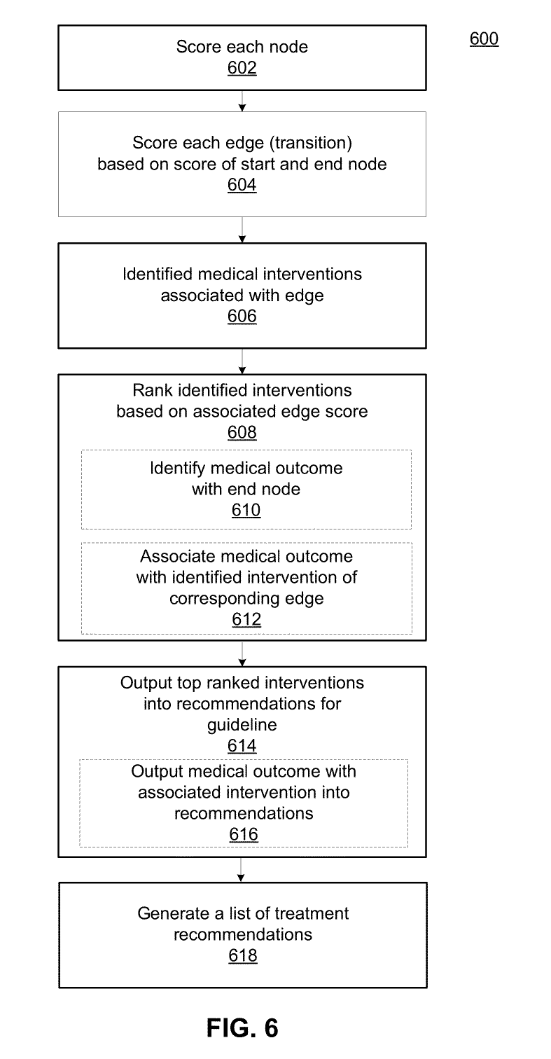

FIG. 6 is a flow chart illustrating a method for creating medical guidelines for treating a patient with a pre-defined disease or medical condition in accordance with one embodiment. The method includes scoring 602 each node in a patient trajectory graph. Additionally, each edge, representing a transition between different or identical nodes, is scored 604 based on the scores of the start and end nodes of the edge. The method then identifies 606 a medical intervention that is associated with this edge (transition), and ranks those identified interventions based on the scores of their associated edges. In some embodiments, the method also includes identifying 610 a medical outcome that is associated with an end node of each edge, then associating 612 the outcome with the edge's intervention. Next, the top ranked interventions (according to their edge scores) are outputted 614 into recommendations for medical guidelines. In particular, medical outcomes associated with each intervention are also outputted 616 into these recommendations. Lastly, a list of treatment recommendations is generated 618 based on those outputted recommendations. In another embodiment, previously created medical guidelines are updated by including those outputted recommendations. In this embodiment, prior to including those outputted recommendations the guidelines' existing recommendations are ranked with respect to those outputted recommendations and then either amended or replace by the outputted recommendation based on their ranking.

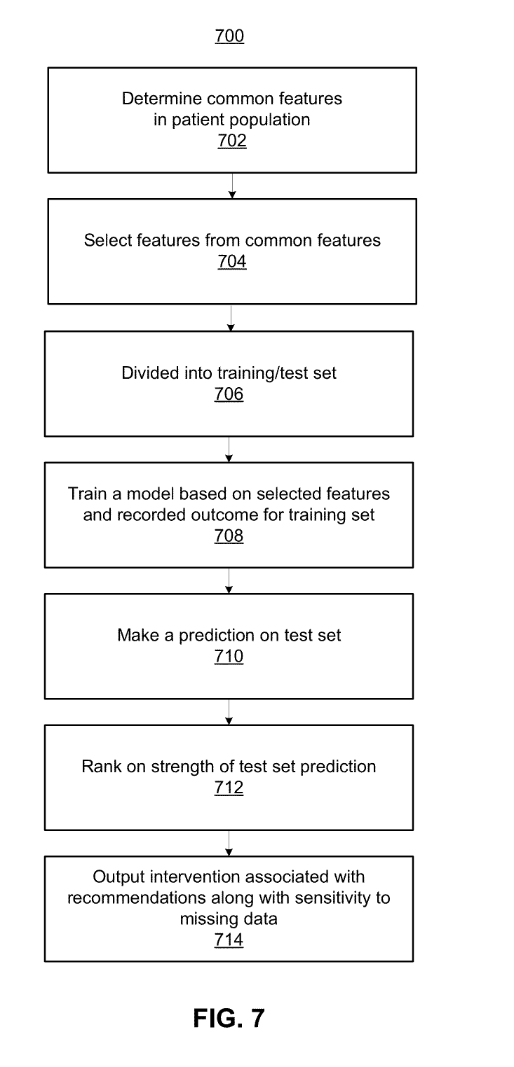

FIG. 7 is a flow chart illustrating a more general method for creating medical guidelines for treating a patient with a pre-defined disease or medical condition in accordance with one embodiment. The method begins by determining 702 common features in the medical records of a pre-defined patient population that shares a medical disease or condition. The next step includes selecting 704 a subset of features from this set of common features. The underlying patient population is divided 706 into a training and test set of patients with the training set being used to train 708 a model including the selected features and recorded medical outcomes, and the model's final predictive performance being evaluated on the test set 710. The construction of the model creates a weight for each feature (how predictive it is of the outcome of interest, after controlling for the other features), which can be used to rank the features according to their importance for predicting 710 the outcome of interest. The highest-ranked features are those that should be addressed in the construction of guidelines. Test set prediction performance is used to assess the overall strength of the guideline recommendation 712, as weak prediction performance means that even if the appropriate features are controlled via a guideline, the resultant effect of such a guideline on a particular outcome may be minimal. Lastly, the method outputs 714 the top recommendation along with the sensitivity of the method with regards to missing data.

### Estimating the Effect Size of Medical Treatment

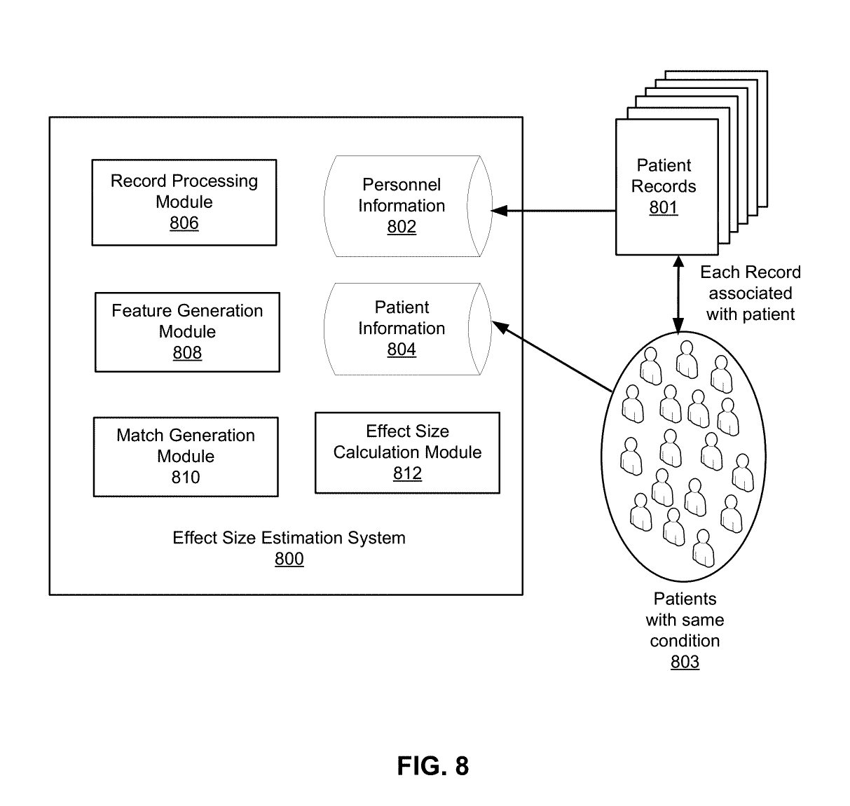

FIG. 8 is an illustration of an effect size estimation system 800 in accordance with one embodiment. The effect size estimation system 800 determines the effect size for a pre-defined patient pool and desired medical outcome (effect) measured for patients within that patient pool by: (i) processing medical records, (ii) identifying features and medical outcomes within those records, (iii) matching patient from the pool based on common confounders (features), and (iv) calculate an average effect size by bootstrapping various match choices of patients. To perform these various functions, the effect size estimation system 800 includes a medical records store 802, a patient information store 804, a record processing module 806, a feature generation module 808, a match generation module 810, and an effect size calculation module 812. Each of the modules and data stores included in the system 800 is discussed in detail below.

The medical records store 802 and patient information store 804 provides access to longitudinal electronic medical record data for patients 803, as described in detail with reference to FIG. 1. Individual patient information is stored in the patient information store 804, whereas the patient's corresponding medical records 801 are stored in the medical records store 802. As described above, in one embodiment each medical patient record 801 in the medical records store 802 is associated with the personal patient information in the patient information store through a patient identification (ID) number that uniquely identifies the patient. To estimate the effect size for treating a medical disease or condition, patients 803 sharing a disease or condition are pooled together and their medical records and patient information are associated with each other. The record processing module 806 processes each medical record to facilitate generating features based on those medical records, according to one embodiment. This processing includes temporally mapping medical records being considered for estimating an effect size on a timeline. By identifying a date and time contained in those records the processing module 806 generates a history of medical records, as described in more detail above. Furthermore, the record processing module 806 is configured to format the patient records and profiles into a format that can be readily processed by the other modules of effect size estimation system 800.

### Identification of Common Confounders

The feature generation module 808 analyses the medical records and patient information to generate features used for determining matches between patients in the patient pool, according to one embodiment. As described with reference to FIG. 1, the feature generation module parses information contained in the medical records and associates (identifies) the parsed information with pre-defined clinical or medical features, which may include but are not limited to medical outcomes for treatments of patients. To identify features and outcomes among large record collections, the feature generation module may use terminologies, ontologies providing domain specific lexicons, and contextual annotations for use in natural language processing, indexing, and information retrieval. The feature generation module typically identifies common confounders (features) that include but are not limited to the patient's age, gender, sex, race, geographic location of residency and where the patient is medically treated and monitored, e.g. the location of the patient's hospital, and frequency of drug administration.

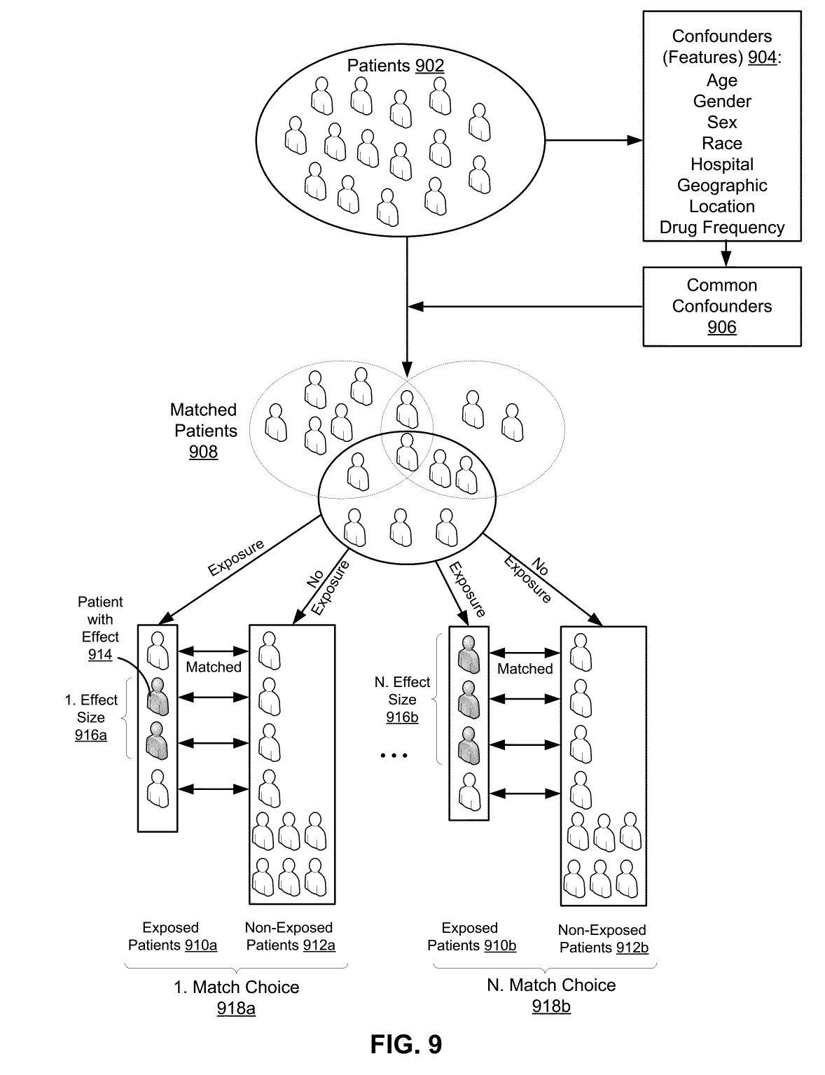

The match generation module 810 uses these common confounders to match (cluster) the patients who are included in the patient pool for which the estimation system 800 determines the effect size of a particular treatment, according to one embodiment. The effect size calculation module 812 then uses a boot-strapping algorithm with respect to matched patients to determine the effect size as explained in more detail with respect to FIG. 9. The effect size estimation system 800 returns as an output the effect size for a specified outcome shared among patient within a pre-defined patient pool.

### Generation of Match Choices (Bootstrap)

FIG. 9 is an illustration of the match generation module 810 and effect size calculation module 812 determining match choices among patients and effect sizes among those matches in accordance with one embodiment. To match patients among a patient pool 902 the match generation module 810 uses the patients' common confounders determined by the feature generation module 808. In one embodiment, the common confounders used to cluster patients in the pool 902 include the age and gender of the patient. Patients who lack the chosen common confounder are removed from the pool 902 prior to further analysis. Thus, in some embodiments the match generation module prunes the patient pools 902 according to the selected confounders.

Match generation module 810 repeats N times matching patients from the exposed group E with patients from the non-exposed group F, each time creating a different match choice between patients from group E and F, according to one embodiment. Exposure means that a patient from this group has experienced a treatment or other kind of medical intervention. More specifically, the match generation module 810 samples patients from group F including replacements (“bootstrapping”), resulting in some match choices between patients being identical, while other matches differ. Typically, when the size of group F significantly exceeds the size of group E, the likelihood that the matches differ is increased.

The bootstrap is a general tool for assessing statistical accuracy. An introduction to the bootstrap method is provided in Efron, B, and Tibshirani, R. J., “An introduction to the bootstrap,” Vol. 57, CRC press, which is incorporated by reference herein in its entirety. The basic idea of bootstrapping involves randomly drawing multiple datasets with replacement from the training data, each sample having the same size as the original training set. Here, the size of the training set is given by the number of patients in the exposed group E. The drawing (creating match choices) is done N times, e.g. N equaling 1000, resulting in N bootstrap datasets, also referred to as match choices. Subsequently, the effect size of each match choice is determined. From the bootstrap sampling the distribution of the effect size can be estimated by averaging over the N bootstrap datasets. Various embodiments employ different methods to estimate the bootstrap error. One method involves evaluating a loss function averaged over all patients within bootstrap datasets and over all bootstrap datasets. Another method mimics cross-validation and is typically includes leave-one-out bootstrap estimate of prediction error, while yet another method involves the “0.632 estimator,” which can further be improved by considering an amount of overfitting. These methods are described in more detail in Hastie, T, Tibshirani, R. J. and Friedman, J, “The Elements of Statistical Learning,” Springer (2001), which is incorporated by reference herein in its entirety.

For each match choice of a bootstrap run, the effect size calculation module 812 divides the patients into two groups, one group (E) being patients exposed to the treatment, for which an effect size is determined, and the other group (F) of patients who have not been exposed to such treatment. For each match choice, each patient i from the exposed group E are selected and randomly matched with a patient j from the non-exposed group F. The matched patient j from group F is then “blacklisted” for that bootstrap run and cannot be match to another patient k from group E with k not being equal to i. Thus, for a particular match choice every selected patient from group E is matched to different patient from group F. Since the number of patients included in group F is typically much larger than the number of patients included in group E, each patient from group E is also matched to a different patient from group F for each of the match choice in the N bootstrap runs. The likelihood that a patient from group E is matched with the same patient from group F for two different match choices increases with decreasing number of patients who are included in group F.

In one embodiment, for which the number of patients in group E equals about the number of patients in group F, the match generation module 810 randomly reduces the number of patients in group E to be included in bootstrap runs. By removing patients from group E the module 810 can match all remaining exposed patients to patients from the non-exposed group F. Instead of randomly reducing the number, the match generation module 810 may reduce the number of patients in group to be included in the bootstrap runs by only considering the most diverse set of patients within the exposed group. Since for each bootstrap run all patients from the exposed group E are matched to non-exposed patients, the number of exposed patients for each match choice is constant and equal to the total number of patients considered from the exposed group E.

In another embodiment with insufficient age- and gender-matched patients in the non-exposed group F as to exposed group E, the excess patients from group E are not matched to any patient from group F, and are therefore excluded from the effect size calculation. For example, the exposed group may include 20 exposed female patients from age 40-50, but the non-exposed group only contains ten female patients within the same age range. Consequently, the match generation module 810 selects only ten patients from group E and matches them to patients from non-exposed group F. Since the order in which the match generation module 810 selects those ten patients from group E may be random and thus vary between different bootstrap runs, a different subset of patients from group E may be matched for each run and included in the effect size calculation.

In yet another embodiment, the confounder range associated with each matching bucket may vary and not be constant. For example, the matching generation module may perform age-based matching by bucketing ages into buckets of different bin sizes. Patients may be divided into buckets for ages 0-5, 5-20, 20-50 and 50+ years. In other embodiments, each bucket is equidistantly spaced or its spacing decreases with increasing age.

### Matching of Exposed and Non-Exposed Patients

The match generation module 810 matches patients by bucketing every patient within a group according to the patients' common confounders. The match generation module 810 generates a match between two patients by randomly selecting two patients who fall within the same bucket. In one embodiment, a patient is included in a matching bucket depending on the patient's age and gender. When bucketing patients based on gender and age two matching patients display the same gender and fall within the same age range. In other embodiments, the match generation module 810 generates matching buckets on more than two common confounders, e.g. co-occurring diseases of interest, race or ethnicity, prior treatment with a certain drug or other intervention, or a number of other factors. The number of possible matches for a particular patient depends on the number of patients included in the same matching bucket as that patient. The size of each matching bucket may depend on the selected confounders and the patient pool considered in evaluating the effect size of a treatment or intervention. For example, if the patient pool includes more patients in the age range from 20-25 years and less patients in the range from 60-65 years for the non-exposed group, more possible matches exists for an exposed patient of age 23 than for a 62-year old patient who received the treatment.

In other embodiments, the match generation module 810 matches exposed patients from group E with non-exposed patients from group F who are similar based on a distance metrics employing the selected common confounders between groups E and F. These embodiments require a choice of distance metric, whereas another embodiment evaluates the propensity of score between two different patients. The benefit of bucketing patients according to common confounders is a reduced bias towards patients being over-represented due to their large amount of data associated with those patients. Other benefits include that bucketing patients is computationally efficient for large datasets (on the order of millions of patients), is insensitive to any particular statistical model, does not require any domain expertise, and readily provides an error estimate for estimating the effect size.

### Calculation of Effect Size

The effect size calculation module 812 calculates the effect size by comparing the characteristics of patients for each match choice provided by the match generation module 810, according to one embodiment. The effect size calculation module 812 calculates the effect size for a particular test statistic, comparing the matched patients from the exposed and non-exposed group E and F for a particular match choice. These statistics include, but are not limited to the odds ratio, relative risk or difference of proportions. In one embodiment of such a test, the effect size calculation module 812 evaluates the probability ratio for each of the N match choices (bootstrap datasets). Such a ratio is determined by dividing the probability of whether a patient showing a particular response, e.g. being diagnosed for a disease or experiencing a certain side effect, when exposed to a treatment or medical intervention with the probability of the same response without exposure. The effect size calculation module 812 reports the median and average effect size when considering all N match choices. In some embodiments, module 812 derives a density plot of the effect size over all studies, providing an estimate of the variance of the reported average effect size.

This allows for more accurate estimation of effect sizes and confidence intervals for these effect sizes in situations where data on potential confounding factors are incomplete, which is almost always the case for studies involving data from electronic medical records. Furthermore, this method reduces the effect of erroneous match choices on study outcomes and provides quantitative estimates of how much the choice of matching impacts any estimates.

### Method of Estimating Effect Size for Medical Treatment

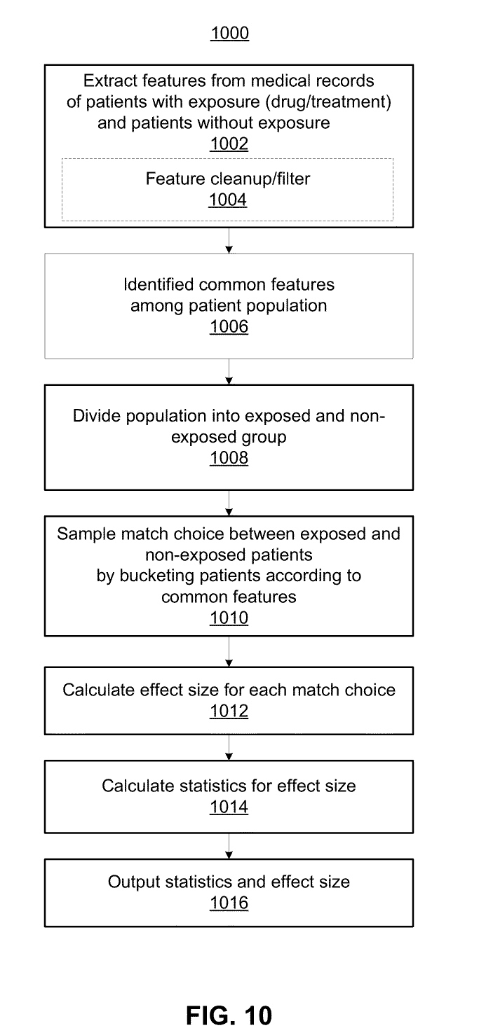

FIG. 10 is a flow chart illustrating a method for estimating an effect size for treating a medical condition or disease within a pre-defined patient population in accordance with one embodiment. The method begins with the feature generation module 808 extracting 1002 features form medical records of patients who were exposed to treatment or other medical intervention and of patients lacking such exposure. In order to extract features common to both groups, exposed and non-exposed, the feature generation module 808 receives these medical records after they were processed by the record processing module 806. In one embodiment, extracted features, also referred to as confounders, are cleaned up and filtered 1004 by the feature generation module 808, resulting in a reduced number of features. Common confounders identified 1006 among the patient population by the feature generation module may include for example the patients' age and gender. In some embodiments, common confounders identified 1006 by the feature generation module may also include, but are not limited sex, race, hospital where treatment is received, geographic location of the patient and drug frequency, among other patient medical and physiological characteristics. The next step in the method includes dividing 1008 the patient population into an exposed and non-exposed group. Subsequently, the method includes determining 1010 match choices between exposed and non-exposed patients based on binning patients with respect to these common confounders, as described in detail with reference to FIG. 9. This is followed by determining 1012 the effect size for each match choice, calculating 1014 its statistics, and outputting 106 the statistics and effect size.

An individual user may access the medical guideline generation system 100 or effect size estimation system 800 via a personal client device, such as a smartphone operated by the individual user. Alternatively, the user may access both systems via a client device shared by a group of users, such as a computer terminal or a conferencing system at a hospital. In other embodiments, the client devices may include a wireless telephone or other devices capable of connecting to the both systems. In some embodiments, the specialized software configured to access and interface with the medical guideline generation system 100 or effect size estimation system 800 may be installed on the client devices. Such software may be different depending on the device that runs the software. In various embodiments, the client devices connect to the medical guideline generation system 100 or effect size estimation system 800 via a communications network, such as a local area network (LAN), a wide area network (WAN), a wireless network, an intranet, or the Internet, for example.

### Exemplary Computing Devices

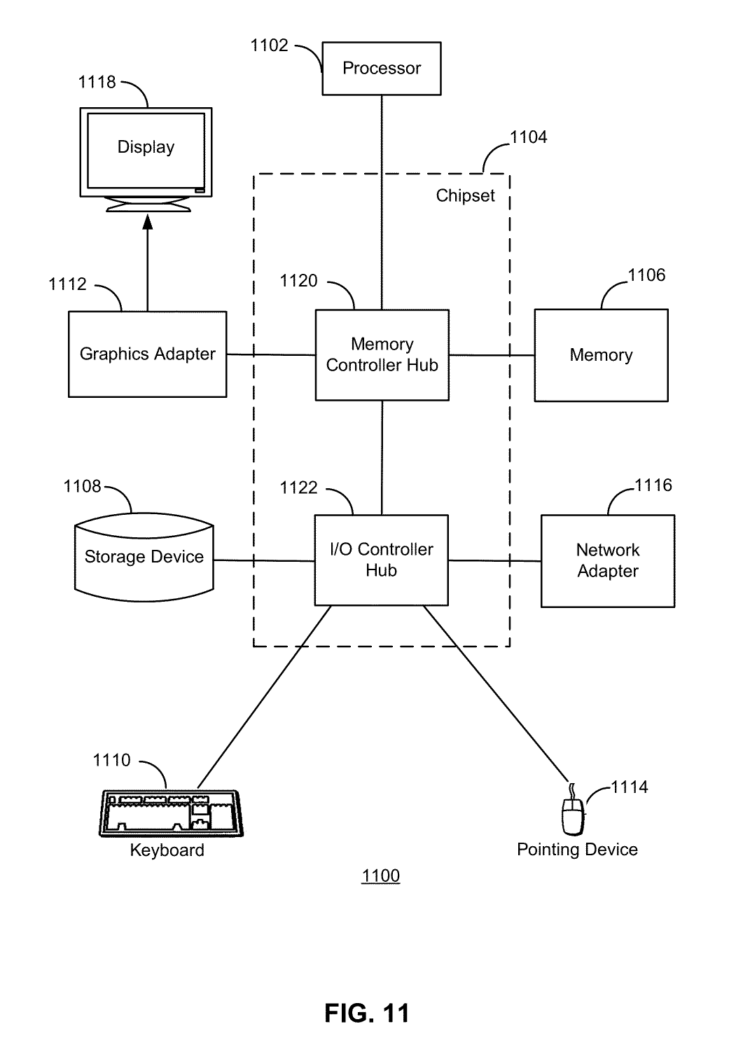

The client devices, the medical guideline generation system 100, and the effect size estimation system 800 discussed above may be implemented using one or more computers. FIG. 11 is a high-level block diagram illustrating an example computer 1100 according to one embodiment.

The computer 1100 includes at least one processor 1102 (e.g., a central processing unit, a graphics processing unit) coupled to a chipset 1104. The chipset 1104 includes a memory controller hub 1120 and an input/output (I/O) controller hub 1122. A memory 1106 and a graphics adapter 1112 are coupled to the memory controller hub 1120, and a display 1118 is coupled to the graphics adapter 1112. A storage device 1108, keyboard 1110, pointing device 1114, and network adapter 1116 are coupled to the I/O controller hub 1122. Other embodiments of the computer 1100 have different architectures.

The storage device 1108 is a non-transitory computer-readable storage medium such as a hard drive, compact disk read-only memory (CD-ROM), DVD, or a solid-state memory device. The memory 1106 holds instructions and data used by the processor 1102. The processor 1102 may include one or more processors 1102 having one or more cores that execute instructions. The pointing device 1114 is a mouse, track ball, or other type of pointing device, and is used in combination with the keyboard 1110 to input data into the computer 1100. The graphics adapter 1112 displays digital content and other images and information on the display 1118. The network adapter 1116 couples the computer 1100 to one or more computer networks (e.g., network 160).

The computer 1100 is adapted to execute computer program modules for providing functionality described herein including presenting digital content, playlist lookup, and/or metadata generation. As used herein, the term “module” refers to computer program logic used to provide the specified functionality. Thus, a module can be implemented in hardware, firmware, and/or software. In one embodiment of a computer 1100 that implements the medical guideline generation system 100, program modules such as the record processing module 106, the feature generation module 108, the patient trajectory graph module 110, the scoring module 112, the intervention and outcome identification module 114, and the recommendation generation module 116 are stored on the storage device 1108, loaded into the memory 1106, and executed by the processor 1102. Similarly, in one embodiment of a computer 1100 that implements the effect size estimation system 800, program modules such as the medical records store 802, the patient information store 804, the record processing module 806, the feature generation module 808, the match generation module 810, and the effect size calculation module 812 are stored on the storage device 1108, loaded into the memory 1106, and executed by the processor 1102.

The present invention has been described in particular detail with respect to several possible embodiments. Those of skill in the art will appreciate that the invention may be practiced in other embodiments. For example, embodiments of the invention have been described in the context of a social network environment. However, it is appreciated that embodiments of the invention may also be practiced in other communications network environments that include components to enable the purchasing of interactive applications and content, and the tracking of licenses and sublicenses as described above. For example, outside the context of the social network provider, any payment provider and/or application developer can manage a system wherein a first user who purchases a use license can also purchase a license to redistribute the application to others or to grant sublicenses to the application. In such circumstances, the payment provider and/or application developer tracks the sublicenses distributed by the first user and allows access to the application by the first user having the license and all additional users having a sublicense.

The particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of above description present the features of the present invention in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “determining” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored on a computer readable medium that can be accessed by the computer and run by a computer processor. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

In addition, the present invention is not described with reference to any particular programming language. It is appreciated that a variety of programming languages may be used to implement the teachings of the present invention as described herein, and any references to specific languages are provided for enablement and best mode of the present invention.

The present invention is well suited to a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention.

What is claimed is:

1. A non-transitory computer readable storage medium storing one or more programs for generating recommendations for medical guidelines, the one or more programs comprising instructions, which when executed by an electronic device, cause the electronic device to:
create a patient trajectory graph based on a plurality of medical records, the patient trajectory graph comprising a plurality of nodes and edges, each edge connecting a node with itself or two separate nodes;
score each node included in the patient trajectory graph and calculate scores of the edges based on the nodes connected to the edge;
identify medical interventions associated with an edge by parsing medical records associated with nodes that the edge connects;
rank the identified medical interventions based on the associated edge score; and
output the top ranked medical interventions as recommendations for medical guidelines.

2. The non-transitory computer readable storage medium of claim 1, wherein each medical record is associated with personal patient information.

3. The non-transitory computer readable storage medium of claim 2, wherein the personal patient information is stored in a patient information store.

4. The non-transitory computer readable storage medium of claim 2, wherein each medical record is associated with a unique patient identification number.

5. The non-transitory computer readable storage medium of claim 1, wherein the one or more programs further comprise instructions, which when executed by an electronic device, cause the electronic device to:
identify each medical record based on a unique patient identification number of a patient, each unique patient identification number associated with the medical record of the patient.

6. The non-transitory computer readable storage medium of claim 1, wherein the one or more programs further comprise instructions, which when executed by an electronic device, cause the electronic device to:
identify each medical record stored in a medical records store based on a unique patient identification number of a patient, wherein each medical record is associated with personal patient information for the patient that is separately stored in a patient information store for patient anonymity and compliance with privacy and medical health record laws.

7. The non-transitory computer readable storage medium of claim 1, wherein the score of the edge is the sum of the scores of the nodes connected to the edge, and the score of each node is based on outcomes included in the medical records associated with the nodes.

8. The non-transitory computer readable storage medium of claim 7, wherein the outcomes are selected from a medical outcome group of a patient consisting: medical conditions or disorders, increased or decreased intake of medication, increased or decreased co-morbidities, expensive or inexpensive treatment options, death or survival, organ failure or recovery, and declining or improving health.

9. The non-transitory computer readable storage medium of claim 7, wherein the score of a node comprises the sum of scores, each score weighed individually and the weight of a score is proportional to a time that patients included in the medical records associated with each node remain with the node before transitioning to another node.

10. The non-transitory computer readable storage medium of claim 9, wherein the transitioning of patients from a node to another node is based on outcome change of the patients included in the medical records associate with the node.

11. A non-transitory computer readable storage medium storing one or more programs for estimating an effect size of a medical treatment on a patient population, the one or more programs comprising instructions, which when executed by an electronic device, cause the electronic device to:
identify common features among the patient population based on evaluating medical records of patients included in the patient population;
divide a patient belonging to the patient population into an exposed or non-exposed group depending on whether the patient received the medical treatment or not;
sample match choices between patients in the exposed and the non-exposed by bucketing patients according to the identified common features;
determine an effect size for each sampled match choice; and
outputting an averaged effect size and its corresponding statistics by averaging the effect size of each sampled match choice.

12. The non-transitory computer readable storage medium of claim 11, wherein the determining an effect size for each sampled match choice comprises bootstrapping the sampled match choices between patients in the exposed and the non-exposed by bucketing patients.

13. The non-transitory computer readable storage medium of claim 11, wherein a common feature of a patient is selected from a group consisting of: age of the patient, gender of the patient, sex of the patient, race of the patient, geographic location of residency of the patient, location where the patient is medically treated and monitored, hospital location of the patient, and frequency of drug administration.

14. The non-transitory computer readable storage medium of claim 11, wherein identifying common features among the patient population comprises parsing information included in the medical records of patients included in the patient population for pre-defined clinical or medical features based on medical terminologies, ontologies providing domain specific lexicons, and contextual medical annotations.

15. The non-transitory computer readable storage medium of claim 11, wherein the common features comprise age and gender of the patients included in the patient population.

16. The non-transitory computer readable storage medium of claim 11, wherein the averaged effect size for each sampled match choice is estimated by averaging over all sampled match choices.

17. The non-transitory computer readable storage medium of claim 11, wherein the effect size equals an error of sampling match choices.

18. The non-transitory computer readable storage medium of claim 17, wherein the effect size comprises an estimate of a bootstrap error.

19. The non-transitory computer readable storage medium of claim 11, wherein the sampling of match choices comprises matching a pre-defined number of patients within a bucket of the exposed group to different patients within the same bucket of the non-exposed group.

20. The non-transitory computer readable storage medium of claim 11, wherein the bucketing comprises assigning each patient within a group to an age bucket according to the age of the patient with the age buckets selected from a group of buckets consisting of buckets for ages 0-5, 5-20, 20-50 and 50+ years.
